(19) United States
(12) Patent Application Publication
(10) Pub. No.: US 2026/0296122 A1
(43) Pub. Date: Oct. 1, 2026

(54) CONTROL SYSTEM FOR VEHICLE

(71) Applicant: TOYOTA JIDOSHA KABUSHIKI KAISHA, Toyota-shi (JP)

(72) Inventor: Hiroki Furuta, Toki-shi (JP)

(73) Assignee: TOYOTA JIDOSHA KABUSHIKI KAISHA, Toyota-shi (JP)

(21) Appl. No.: 19/557,399

(22) Filed: Mar. 5, 2026

(30) Foreign Application Priority Data
Mar. 31, 2025 (JP) 2025-058906

(51) Int. Cl. B60G 17/018; B60G 17/016

(52) U.S. Cl. CPC B60G 17/0182; B60G 17/016; B60G 2400/0511; B60G 2400/0512; B60G 2400/252; B60G 2500/104; B60G 2600/602

(57) ABSTRACT

The high-pass filter is set to cut off components having frequencies equal to or lower than a predetermined frequency based on a result of comparing the heave component, the pitch component, and the roll component included in the parameter related to the vertical motion of each wheel of the vehicle with the predetermined upper limit value, and filtering using the high-pass filter is performed. The high-pass filter includes a first high-pass filter. The first high-pass filter is set when at least one of the heave component, the pitch component, and the roll component is equal to or greater than the predetermined upper limit value. The first high-pass filter includes a first heave filter, a first pitch filter that is weaker than the first heave filter, and a first roll filter that is weaker than the first pitch filter.

### CROSS-REFERENCE TO RELATED APPLICATION

This application claims priority to Japanese Patent Application No. 2025-058906 filed on Mar. 31, 2025. The disclosure of the above-identified application, including the specification, drawings, and claims, is incorporated by reference herein in its entirety.

### BACKGROUND

### 1. Technical Field

The present disclosure relates to a technique for vibration control of a vehicle.

### 2. Description of Related Art

US Patent Application Publication No. 2018/0154723 (US 2018/0154723 A) discloses vibration control using a road surface displacement map representing a correspondence relationship between a road surface displacement (road surface irregularity) and a position. In the vibration control, the road surface displacement at a predetermined position in front of the vehicle is recognized from the road surface displacement map. A control amount of the active suspension is calculated in advance according to the road surface displacement that is recognized. Then, the active suspension is controlled at a timing when the wheel passes through the predetermined position.

### SUMMARY

In the present disclosure, vibration control based on a parameter related to the vertical motion of each wheel of the vehicle is considered. The parameter related to the vertical motion of each wheel can be calculated, for example, based on a detection value from a sensor that detects behavior of each wheel in the vertical direction. However, the parameter related to the vertical motion includes extremely low-frequency components derived from changes in elevation or the like. Therefore, in the vibration control, filtering using a high-pass filter is preferably performed to cut off extremely low-frequency components from the parameter related to the vertical motion. However, when an excessively strong high-pass filter is used, a roll component derived from different vertical displacements of the left and right wheels is also cut from the parameter related to the vertical motion.

When the vibration control is performed based on the parameter related to the vertical motion from which the roll component has been cut off, the roll component is not reflected in the vibration control, and the control effect is reduced. In this regard, the problem can be resolved by using a weak high-pass filter for the filtering. However, in this case, a heave component and a pitch component derived from the same vertical displacement of the left and right wheels that are easily affected by the changes in elevation remain. Then, an excessive control amount that attempts to cancel out the heave component and the pitch component may reduce the control effect.

The present disclosure provides a technique capable of appropriately reflecting a roll component, a heave component, and a pitch component in vibration control based on a parameter related to the vertical motion of each wheel of a vehicle.

The present disclosure provides a control system applied to a vehicle and has the following features.

The system includes:
a sensor for each wheel configured to detect behavior of each wheel of the vehicle;
an actuator for each wheel configured to control a suspension stroke of each wheel; and
one or more processing circuits configured to perform vibration control of the vehicle by controlling the actuator based on a detection value of the sensor.
   The vibration control includes
calculating a parameter related to vertical motion of each wheel based on the detection value of the sensor,
setting a high-pass filter for cutting off components having frequencies equal to or lower than a predetermined frequency from the parameter, based on a result of comparing the parameter with a predetermined upper limit value, and
calculating a control amount for the actuator of each wheel for controlling the suspension stroke based on the parameter from which the components having frequencies equal to or lower than the predetermined frequency have been cut off by filtering using the high-pass filter.
   The parameter includes a heave component in which four wheels of the vehicle perform the same vertical motion, a pitch component in which left and right wheels of the vehicle perform the same vertical motion and front and rear wheels of the vehicle perform different vertical motions, and a roll component in which the left and right wheels of the vehicle perform different vertical motions.
   The high-pass filter includes a first high-pass filter that is set when at least one of the heave component, the pitch component, and the roll component is equal to or greater than the predetermined upper limit value.
   The first high-pass filter includes a first heave filter, a first pitch filter that is weaker than the first heave filter, and a first roll filter that is weaker than the first pitch filter.
when the first high-pass filter is set in the setting of the high-pass filter, in the filtering, the first heave filter or the first pitch filter is applied to the heave component, a filter different from the filter applied to the heave component among the first pitch filter and the first roll filter is applied to the roll component, and the same filter as the filter applied to the heave component or the roll component, or a filter different from the filter applied to the heave component and the roll component among the first heave filter, the first pitch filter, and the first roll filter is applied to the pitch component.

According to the present disclosure, the high-pass filter is set to cut off components having frequencies equal to or lower than a predetermined frequency based on a result of comparing the heave component, the pitch component, and the roll component included in the parameter related to the vertical motion of each wheel of the vehicle with the predetermined upper limit value, and filtering using the high-pass filter is performed. The high-pass filter includes a first high-pass filter. The first high-pass filter is set when at least one of the heave component, the pitch component, and the roll component is equal to or greater than the predetermined upper limit value. The first high-pass filter includes a first heave filter, a first pitch filter that is weaker than the first heave filter, and a first roll filter that is weaker than the first pitch filter.

When the first high-pass filter is set in the high-pass filter for filtering, in the filtering, the first heave filter or the first pitch filter is applied to the heave component. In the filtering, a filter different from the filter applied to the heave component among the first pitch filter and the first roll filter is applied to the roll component. In the filtering, the same filter as the filter applied to the heave component or the roll component, or a filter different from the filter applied to the heave component and the roll component among the first heave filter, the first pitch filter, and the first roll filter is applied to the pitch component.

When at least one of the heave component, the pitch component, and the roll component is equal to or greater than the predetermined upper limit value, filtering is performed by applying the three types of filters for heave, pitch, and roll described above to these components. Accordingly, it is possible to cut off extremely low-frequency components from the heave component while leaving the roll component. Therefore, it is possible to appropriately reflect the roll component, the heave component, and the pitch component in the vibration control performed based on the parameter after the filtering, and to increase the control effect for upper limit motion modes of heave, pitch, and roll.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a configuration example of a vehicle according to the embodiment;

FIG. 2 is a conceptual diagram showing a configuration example of a suspension according to the embodiment; and

FIG. 3 is a flowchart showing an example of vibration control processing according to the embodiment.

### DETAILED DESCRIPTION OF EMBODIMENTS

An embodiment of the present disclosure will be described with reference to the accompanying drawings.

### 1. Vehicle Control System

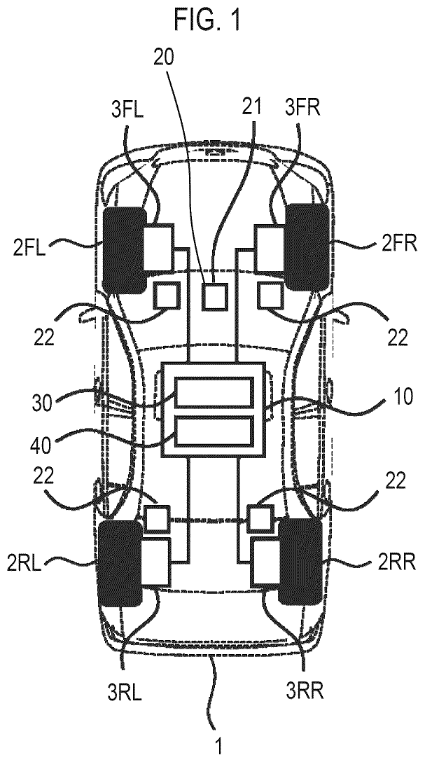

FIG. 1 is a schematic diagram showing a configuration example of a vehicle 1 on which a vehicle control system 10 according to the embodiment is mounted. The vehicle 1 includes wheels 2 and suspensions 3. The wheels 2 include a left front wheel 2FL, a right front wheel 2FR, a left rear wheel 2RL, and a right rear wheel 2RR. The left front wheel 2FL and the right front wheel 2FR constitute left and right wheels on a front wheel axle side, and the left rear wheel 2RL and the right rear wheel 2RR constitute left and right wheels on a rear wheel axle side. Suspensions 3FL, 3FR, 3RL, and 3RR are provided for the left front wheel 2FL, the right front wheel 2FR, the left rear wheel 2RL, and the right rear wheel 2RR, respectively. In the following description, each wheel is referred to as the wheel 2 and each suspension is referred to as the suspension 3 unless otherwise necessary to distinguish.

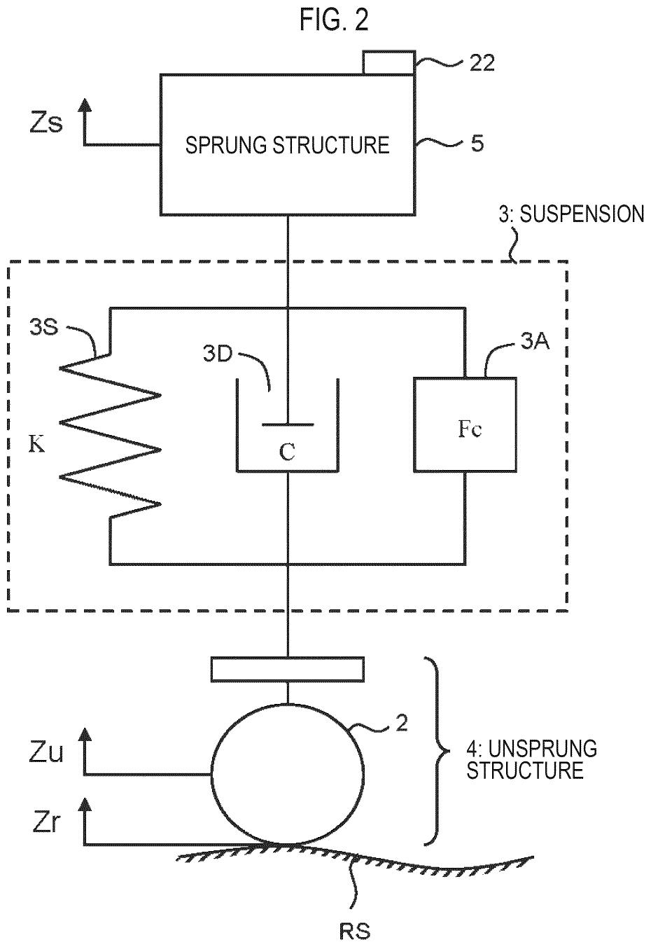

FIG. 2 is a conceptual diagram showing a configuration example of the suspension 3. The suspension 3 is provided to connect an unsprung structure 4 and a sprung structure 5 of the vehicle 1. The unsprung structure 4 includes the wheel 2. The suspension 3 includes a spring 3S, a damper (shock absorber) 3D, and an actuator 3A. The spring 3S, the damper 3D, and the actuator 3A are provided in parallel between the unsprung structure 4 and the sprung structure 5. The spring constant of the spring 3S is K. The damping coefficient of the damper 3D is C. The damping force of the damper 3D may be variable. The actuator 3A applies a control force Fc in the vertical direction between the unsprung structure 4 and the sprung structure 5.

Here, definitions of terms will be provided. The “road surface displacement Zr” is a displacement of a road surface RS in the vertical direction. The “unsprung displacement Zu” is a displacement of the unsprung structure 4 in the vertical direction. The “sprung displacement Zs” is a displacement of the sprung structure 5 in the vertical direction. The “unsprung velocity Zu′” is a velocity of the unsprung structure 4 in the vertical direction. The “sprung velocity Zs′” is a velocity of the sprung structure 5 in the vertical direction. The “unsprung acceleration Zu′” is an acceleration of the unsprung structure 4 in the vertical direction. The “sprung acceleration Zs′” is an acceleration of the sprung structure 5 in the vertical direction. It should be noted that a sign of each parameter is positive in an upward direction and negative in a downward direction.

The wheel 2 moves on the road surface RS. In the following description, a parameter related to the vertical motion of the wheel 2 will be referred to as a “vertical motion parameter”. Examples of the vertical motion parameter include the road surface displacement Zr, the unsprung displacement Zu, the unsprung velocity Zu′, the unsprung acceleration Zu″, the sprung displacement Zs, the sprung velocity Zs′, and the sprung acceleration Zs″. The vertical motion parameter can also be referred to as a “road surface displacement parameter” related to the road surface displacement Zr.

The vehicle control system 10 according to the embodiment includes a sensor 20. The sensor 20 includes a vehicle speed sensor (wheel speed sensor) 21 that detects a vehicle speed V of the vehicle 1, a sprung acceleration sensor 22 that detects the sprung acceleration Zs″, and the like. The sprung acceleration sensor 22 is provided for each of the left front wheel 2FL, the right front wheel 2FR, the left rear wheel 2RL, and the right rear wheel 2RR. The sensor 20 may include a stroke sensor that detects a stroke ST (=Zs−Zu) that is a relative displacement between the sprung structure 5 and the unsprung structure 4. The sensor 20 may include an unsprung acceleration sensor. In addition, the sensor may include a lateral acceleration sensor, a yaw rate sensor, a steering angle sensor, and the like.

The vehicle control system 10 also includes one or more processing circuits 30 (hereinafter, simply referred to as a “processing circuit 30”) and one or more storage devices 40 (hereinafter, simply referred to as a “storage device 40”). The processing circuit 30 executes various types of processing. For example, the processing circuit 30 includes a central processing unit (CPU). The storage device 40 stores various types of information. Examples of the storage device 40 include a volatile memory, a non-volatile memory, a hard disk drive (HDD), and a solid state drive (SSD). The functions of the vehicle control system 10 may be implemented by the processing circuit 30 executing a vehicle control program. The vehicle control program may be recorded on a computer-readable recording medium.

The vehicle control system 10 (processing circuit 30) controls the suspension 3. Typically, the vehicle control system 10 (processing circuit 30) performs vibration control by controlling the suspension 3 to suppress vibration of the sprung structure 5 of the vehicle 1 (target vehicle). For example, the vehicle control system 10 (processing circuit 30) controls the actuator 3A to generate the control force Fc in the vertical direction between the unsprung structure 4 and the sprung structure 5, thereby suppressing the vibration of the sprung structure 5. Hereinafter, the vibration control will be described in more detail.

### 2. Vibration Control

As an example, in the following description, a case in which the road surface displacement-related value is the unsprung displacement Zu or the sprung displacement Zs will be considered. In a case of generalization, the “unsprung displacement” or the “sprung displacement” in the following description will be replaced with a “road surface displacement-related value”.

The unsprung displacement Zu and the sprung displacement Zs can be calculated based on the detection value of the sensor 20. However, since the detection value of the sensor 20 includes the extremely low-frequency components derived from the changes in elevation or the like, the unsprung displacement Zu or the sprung displacement Zs calculated based on the detection value also include such extremely low-frequency components. Therefore, it is desirable to perform filtering using a high-pass filter in the vibration control to cut off the extremely low-frequency components. However, when an excessively strong high-pass filter is used, a left-right wheel out-of-phase component (that is, the roll component) derived from different vertical displacements of the left and right wheels is also cut off from the unsprung displacement Zu or the sprung displacement Zs.

When the vibration control is performed based on the unsprung displacement Zu or the sprung displacement Zs from which the roll component has been cut off, the roll component is not reflected in the vibration control, and the control effect is reduced. In this regard, the problem can be resolved by using a weak high-pass filter for the filtering. However, in this case, a left-right wheel in-phase component (four-wheel in-phase component and left-right wheel in-phase and front-rear wheel out-of-phase component, that is, the heave component and the pitch component) derived from the same vertical displacements of the left and right wheels that are easily affected by the changes in elevation remains. Then, an excessive control amount that attempts to cancel out the heave component and the pitch component may reduce the control effect.

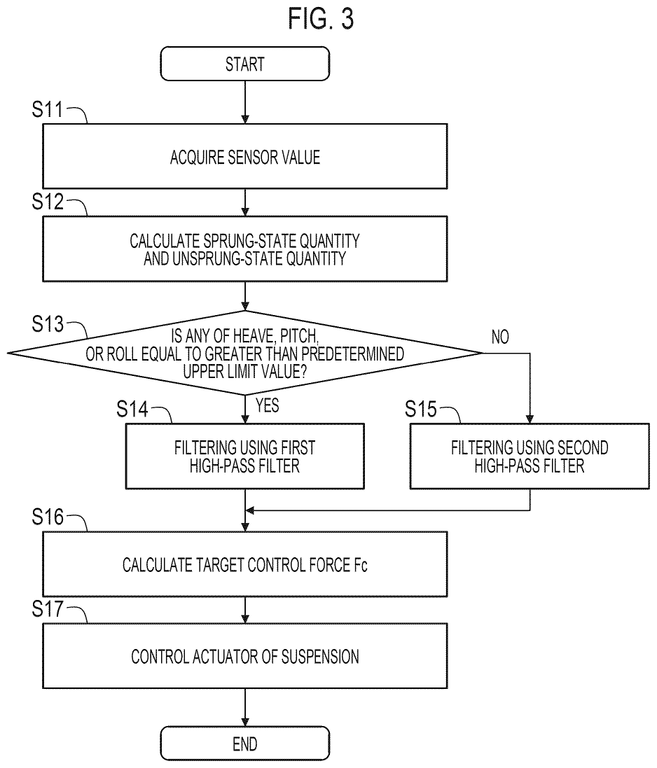

Therefore, in the embodiment, in order to appropriately reflect the roll component, the heave component, and the pitch component in the vibration control, the high-pass filter used for the filtering is set with reference to a state quantity (specifically, acceleration, velocity, or displacement) of a sprung-mass center of gravity or an unsprung-mass center of gravity. FIG. 3 is a flowchart showing an example of vibration control processing according to the embodiment. The processing routine shown in FIG. 3 is repeatedly executed by, for example, the processing circuit 30.

In the example shown in FIG. 3, in S11, the detection value (sensor value) of the sensor 20 is acquired. The sensor value includes the vehicle speed acquired by the vehicle speed sensor 21 and the sprung acceleration Zs″ acquired by the sprung acceleration sensor 22. When the unsprung displacement Zu is calculated, the sensor value may include the stroke ST acquired by the stroke sensor and the unsprung acceleration acquired by the unsprung acceleration sensor. The stroke ST may be estimated based on the sprung acceleration Zs″ by an observer configured based on a single-wheel two-degree-of-freedom model.

Following S11, in S12, each acceleration component (the heave component Zg″, the roll component Φg″, and the pitch component Θg″) of the sprung-mass center of gravity is calculated. Each acceleration component is calculated by, for example, the following equations (1) to (3), using as variables the positions of the three sprung acceleration sensors 22 provided at the left front wheel 2FL, the right front wheel 2FR, and the right rear wheel 2RR and the sensor values (that is, the sprung acceleration Zs″ (s=1 to 3)) acquired in S11.

$$\begin{matrix}Equation 1 & \\ \ddot{Z} g = {{\sum }_{s = 1}}^{3} \{ M ( 1 , s ) {L}_{g} + M ( 3 , s ) \} \ddot{Z} s & ( 1 )\end{matrix}$$

$$\ddot{Φ} g = - {{\sum }_{s = 1}}^{3} \{ M ( 2 , s ) \} \ddot{Z} s \qquad ( 2 )$$

$$\ddot{Θ} g = {{\sum }_{s = 1}}^{3} M ( 1 , s ) \ddot{Z} s \qquad ( 3 )$$

$$M = {[ \begin{matrix}{L}_{1} & {W}_{1} & 1 \\ {L}_{2} & {W}_{2} & 1 \\ {L}_{3} & {W}_{3} & 1\end{matrix} ]}^{- 1}$$

It should be noted that, in the equations (1) to (3), L₁ and L₂ are an x-direction position of the sprung acceleration sensor 22 of the right front wheel 2FR and an x-direction position of the sprung acceleration sensor 22 of the left front wheel 2FL, respectively. L₃ and L_{g} are an x-direction position of the sprung acceleration sensor 22 of the right rear wheel 2RR and an x-direction position of the sprung-mass center of gravity, respectively. In addition, W₁, W₂, and W₃ are a y-direction position of the sprung acceleration sensor 22 of the right front wheel 2FR, a y-direction position of the sprung acceleration sensor 22 of the left front wheel 2FL, and a y-direction position of the sprung acceleration sensor 22 of the right rear wheel 2RR, respectively. In addition, the equations (1) to (3) are based on a coordinate system in which a vehicle traveling direction is x, a lateral direction is y, and a vertical direction is z.

In addition, each velocity component (the heave component Zg′, the roll component Φg′, and the pitch component Θg′) of the sprung-mass center of gravity is calculated by a first-order integration of each acceleration component of the heave component Zg″, the roll component Dg″, and the pitch component Θg″. Each displacement component (the heave component Zg, the roll component Φg, and the pitch component Θg) of the sprung-mass center of gravity is calculated by a second-order integration of each acceleration component of the heave component Zg″, the roll component Dg″, and the pitch component Θg″.

In S12, each displacement component (the heave component Zg, the roll component Φg, and the pitch component Θg) of the unsprung-mass center of gravity may be calculated. Each displacement component is calculated, for example, by decomposing a difference (Zu=ST−Zs) between the stroke ST acquired in S11 and each integrated value obtained by performing a second-order integration on the sprung acceleration Zs″ (s=1 to 4) acquired in the same S11 into each vertical motion mode according to the following equations (4) to (7).

$$\begin{matrix}Equation 2 & \\ Zufin = \frac{{Z}_{1} + {Z}_{2}}{2} & ( 4 )\end{matrix}$$

$$Zufan = \frac{{Z}_{1} - {Z}_{2}}{2} \qquad ( 5 )$$

$$Zurin = \frac{{Z}_{3} - {Z}_{4}}{2} \qquad ( 6 )$$

$$Zuran = \frac{{Z}_{3} - {Z}_{4}}{2} \qquad ( 7 )$$

In the equations (4) to (7), Zufin is a heave component of the front and rear left and right wheels, Zufan is a roll component of the front and rear left and right wheels, Zurin is a heave component of the rear left and right wheels, and Zuran is a roll component of the rear left and right wheels. In addition, Z₁ represents the unsprung displacement Zu of the right front wheel 2FR, and Z₂ represents the unsprung displacement Zu of the left front wheel 2FL. Z₃ represents the unsprung displacement Zu of the right rear wheel 2RR, and Z₄ represents the unsprung displacement Zu of the left rear wheel 2RL.

The heave component Zg of the unsprung-mass center of gravity is calculated, for example, as a sum of the heave component Zufin and the heave component Zurin. The roll component Φg of the unsprung-mass center of gravity is calculated, for example, as a sum of the roll component Zufan and the roll component Zuran. The pitch component Θg of the unsprung-mass center of gravity is calculated, for example, as a sum of the heave component Zufin and the roll component Zuran or a sum of the heave component Zurin and the roll component Zufan. The heave component Zufin and the heave component Zurin of the left and right wheels may be decomposed into front and rear wheels in-phase and front and rear wheels out-of-phase. The front and rear wheels in-phase is a value obtained by dividing a sum of the heave component Zufin and the heave component Zurin by 2. The front and rear wheels out-of-phase is a value obtained by dividing a difference between the heave component Zufin and the heave component Zurin by 2.

As another example, the unsprung acceleration Zu″ and each displacement component (the heave component Zg, the roll component Φg, and the pitch component Θg) of the unsprung-mass center of gravity may be calculated. The unsprung acceleration Zu″ is detected by the unsprung acceleration sensor. Each displacement component of the unsprung-mass center of gravity is calculated by the same method as a method of calculating each acceleration component of the sprung-mass center of gravity using the equations (1) to (3).

Following S12, in S13, it is determined whether the state quantity (acceleration, velocity, or displacement) of the sprung-mass center of gravity calculated in S12 is equal to or greater than a predetermined upper limit value. When the state quantity of the unsprung-mass center of gravity is calculated in S12, it may be determined whether the state quantity of the unsprung-mass center of gravity is equal to or greater than the predetermined upper limit value instead of the state quantity of the sprung-mass center of gravity.

The state quantity of the sprung-mass center of gravity (or the unsprung-mass center of gravity) may be directly used as the value calculated in S12, or a moving average value of a plurality of state quantities obtained over a predetermined sampling period preceding the current processing routine may be used. A value (acceleration, velocity, or displacement) corresponding to the state quantity to be compared with the predetermined upper limit value is set in advance as a state quantity (acceleration, velocity, or displacement) that exceeds the capability of the actuator or the suspension stroke, or as a state quantity close to such an upper limit.

The determination in S13 is performed by focusing on any one of the acceleration component, the velocity component, or the displacement component. Specifically, when the comparison based on the acceleration component is performed, it is determined whether at least one of the heave component Zg″, the roll component Dg″, and the pitch component Θg″ is equal to or greater than a predetermined upper limit value for the acceleration component. When the comparison based on the velocity component is performed, it is determined whether at least one of the heave component Zg′, the roll component Φg′, and the pitch component Θg′ is equal to or greater than a predetermined upper limit value for the velocity component. When the comparison based on the displacement component is performed, it is determined whether at least one of the heave component Zg, the roll component Φg, and the pitch component Θg is equal to or greater than a predetermined upper limit value for the displacement component.

When the determination result in S13 is affirmative, the processing in S14 is performed. In S14, filtering using the first high-pass filter is performed. Here, the first high-pass filter includes three types of high-pass filters. Specifically, the three types of high-pass filters are a first heave filter, a first pitch filter that is weaker than the first heave filter, and a first roll filter that is weaker than the first pitch filter. The “weak” high-pass filter as used herein means that the cutoff frequency (on the low-frequency side) is low, the filter order is small, or the number of filter stages is small.

For example, the cutoff frequency of the first heave filter is set to a frequency at which the extremely low-frequency components (for example, components of 0.5 Hz or less) derived from the changes in elevation or the like are cut off. The cutoff frequency of the first roll filter is set to a frequency (for example, 0.2 Hz) that allows frequency components including the roll component to remain. The cutoff frequency of the first pitch filter is set to a frequency (for example, 0.3 to 0.4 Hz) between these frequencies.

The first heave filter is applied to the heave component (acceleration, velocity, or displacement component). The first pitch filter is applied to the pitch component (acceleration, velocity, or displacement component). The first roll filter is applied to the roll component (acceleration, velocity, or displacement component). However, any two of the filters may be the same. For example, the same filter (the first heave filter or the first pitch filter) may be applied to the heave component and the pitch component, and the first roll filter may be applied to the roll component. The first heave filter may be applied to the heave component, and the same filter (the first pitch filter or the first roll filter) may be applied to the pitch component and the roll component.

In addition, among the first high-pass filters applied to the acceleration, velocity, and displacement components, the first high-pass filter applied to the displacement component may be set to be strongest, the first high-pass filter applied to the velocity component and the first high-pass filter applied to the acceleration component may be set to be weaker in this order. Specifically, the first heave filter applied to the heave component Zg, the first heave filter applied to the heave component Zg′, and the first heave filter applied to the heave component Zg″ may be set to be weaker in this order. The first pitch filter applied to the pitch component Θg, the first pitch filter applied to the pitch component Θg′, and the first pitch filter applied to the pitch component Θg″ may be set to be weaker in this order. The first roll filter applied to the roll component Φg, the first roll filter applied to the roll component Φg′, and the first roll filter applied to the roll component Dg″ may be set to be weaker in this order.

When the determination result in S13 is negative, the processing in S15 is performed. In S15, filtering using the second high-pass filter is performed. The second high-pass filter includes three types of filters as in the first high-pass filter. Specifically, the three types of high-pass filters are a second heave filter, a second pitch filter that is weaker than the second heave filter, and a second roll filter that is weaker than the second pitch filter. Here, the second heave filter is a filter that is weaker than the first heave filter. In addition, the second pitch filter is a filter that is weaker than the first pitch filter, and the second roll filter is a filter that is weaker than the first roll filter.

The negative determination result in S13 means that the state quantity of the sprung-mass center of gravity or the unsprung-mass center of gravity calculated in S12 is less than the predetermined upper limit value. Therefore, a filter that is weaker than the first heave filter, the first pitch filter, and the first roll filter is used for the second heave filter, the second pitch filter, and the second roll filter, respectively. In addition, the state quantity of the sprung-mass center of gravity or the unsprung-mass center of gravity being less than the predetermined upper limit value means that the influence of using the single high-pass filter described above is small. Therefore, in S15, filtering using any one type of filter of the second heave filter, the second pitch filter, and the second roll filter may be performed.

As with the first high-pass filter, any two of the filters applied to the heave component, pitch component, and roll component may be the same. That is, the same filter (the second heave filter or the second pitch filter) may be applied to the heave component and the pitch component, and the second roll filter may be applied to the roll component. The second heave filter may be applied to the heave component, and the same filter (the second pitch filter or the second roll filter) may be applied to the pitch component and the roll component.

In addition, as in the first high-pass filter, among the second high-pass filters applied to the acceleration, velocity, and displacement components, the second high-pass filter applied to the displacement component may be set to be strongest, the second high-pass filter applied to the velocity component and the second high-pass filter applied to the acceleration component may be set to be weaker in this order. That is, the second heave filter applied to the heave component Zg, the second heave filter applied to the heave component Zg′, and the second heave filter applied to the heave component Zg″ may be set to be weaker in this order. The second pitch filter applied to the pitch component Θg, the second pitch filter applied to the pitch component Θg′, and the second pitch filter applied to the pitch component Θg″ may be set to be weaker in this order. The second roll filter applied to the roll component Φg, the second roll filter applied to the roll component Φg′, and the second roll filter applied to the roll component Dg″ may be set to be weaker in this order.

Following S14 or S15, in S16, the target control force Fc of the actuator 3A is calculated based on the state quantity of the sprung-mass center of gravity after the filtering. The target control force Fc is, for example, a target control force for the sprung velocity feedback control that suppresses vibrations based on each velocity component of the sprung-mass center of gravity after the filtering. The target control force Fc (c=1 to 4) based on each velocity component of the sprung-mass center of gravity after the filtering is calculated, for example, by the following equation (8).

$$\begin{matrix}Equation 3 & \\ [ \begin{matrix}{F}_{1} \\ {F}_{2} \\ {F}_{3} \\ {F}_{4}\end{matrix} ] = [ \begin{matrix}\frac{lr}{2 ( lf + lr )} & - \frac{1}{2 Tf} & - \frac{1}{4 lf} \\ \frac{lr}{2 ( lf + lr )} & - \frac{1}{2 Tf} & - \frac{1}{4 lf} \\ \frac{lf}{2 ( lf + lr )} & - \frac{1}{2 Tr} & - \frac{1}{4 lr} \\ \frac{lf}{2 ( lf + lr )} & - \frac{1}{2 Tr} & - \frac{1}{4 lr}\end{matrix} ] [ \begin{matrix}* \dot{Z} g \cdot α zg \\ * \dot{Φ} g \cdot αΦ \\ * \dot{Θ} g \cdot αΘ\end{matrix} ] & ( 8 )\end{matrix}$$

In the equation (8), F₁ is the target control force Fc of the actuator 3A of the right front wheel 2FR, and F₂ is the target control force Fc of the actuator 3A of the left front wheel 2FL. F₃ is the target control force Fc of the actuator 3A of the right rear wheel 2RR, and F₄ is the target control force Fc of the actuator 3A of the left rear wheel 2RL. If is a distance from the sprung-mass center of gravity to the front wheels (front overhang), and lr is a distance from the sprung-mass center of gravity to the rear wheels (rear overhang). Tf is a tread of the front and rear left and right wheels, and Tr is a tread of the rear left and right wheels. *Zg′ is a vertical velocity after filtering, *Φg′ is a roll angular velocity, and *Θg′ is a pitch angular velocity after filtering. αzg, αΦ, and αΘ are gains corresponding to each velocity term.

In another example, the target control force Fc is a target control force for sprung velocity feedback control that suppresses vibrations based on each displacement component of the sprung-mass center of gravity after the filtering. In yet another example, the target control force Fc is a target control force for sprung velocity feedback control that suppresses vibrations based on each acceleration component of the sprung-mass center of gravity after the filtering. In still another example, the target control force Fc is a target control force for sprung velocity feedback control that suppresses vibrations by summing two or more components among the velocity components, displacement components, and angular velocity components of the sprung-mass center of gravity of gravity after the filtering.

In S16, when the state quantity of the unsprung-mass center of gravity is calculated in step S12, the target control force Fc of the actuator 3A may be calculated based on the state quantity of the unsprung-mass center of gravity after the filtering instead of the state quantity of the sprung-mass center of gravity after the filtering. In this case, the target control force Fc is a target control force for sprung velocity feedback control that suppresses vibrations based on each displacement component of the unsprung-mass center of gravity after the filtering. The target control force Fc (c=1 to 4) based on each displacement component of the unsprung-mass center of gravity after the filtering is calculated, for example, by the following equations (9) to (12).

$$\begin{matrix}Equation 4 & \\ {F}_{1} = * Zufin \cdot α fin + * Zufan \cdot α fan & ( 9 )\end{matrix}$$

$${F}_{2} = * Zufin \cdot α fin - * Zufan \cdot α fan \qquad ( 10 )$$

$${F}_{3} = * Zurin \cdot α rin + * Zuran \cdot α ran \qquad ( 11 )$$

$${F}_{4} = * Zurin \cdot α rin - * Zuran \cdot α ran \qquad ( 12 )$$

In the equations (9) to (12), F₁ is the target control force Fc of the actuator 3A of the right front wheel 2FR, and F₂ is the target control force Fc of the actuator 3A of the left front wheel 2FL. F₃ is the target control force Fc of the actuator 3A of the right rear wheel 2RR, and F₄ is the target control force Fc of the actuator 3A of the left rear wheel 2RL. *Zufin is a heave component of the front left and right wheels after the filtering, and *Zufan is a roll component of the front left and right wheels after the filtering. *Zurin is a heave component of the rear left and right wheels after the filtering, and *Zuran is a roll component of the rear left and right wheels after the filtering. αfin is a front left and right wheels in-phase gain, αfan is a front left and right wheels out-of-phase gain, αrin is a rear left and right wheels in-phase gain, and αran is a rear left and right wheels out-of-phase gain.

Following S16, in S17, the actuator 3A is controlled to generate the target control force Fc calculated in S16.

### 3. Effects

According to the embodiment described above, the filtering is performed in which the three types of filters for heave, pitch, and roll are applied to the heave component, the pitch component, and the roll component. Therefore, it is possible to cut off the extremely low-frequency components from the heave component while leaving the roll component. In particular, when at least one of the heave component, the pitch component, and the roll component is equal to or greater than the predetermined upper limit value, the filtering using the first heave filter, the first pitch filter, and the first roll filter is performed. Therefore, when the influence of using the single high-pass filter described above becomes large, it is possible to cut off the extremely low-frequency components from the heave component while leaving the roll component. Therefore, it is possible to appropriately reflect the roll component, the heave component, and the pitch component in the vibration control performed based on the parameter after the filtering, and to increase the control effect for upper limit motion modes of heave, pitch, and roll.

What is claimed is:

1. A control system applied to a vehicle, the control system comprising:
a sensor for each wheel configured to detect behavior of each wheel of the vehicle;
an actuator for each wheel configured to control a suspension stroke of each wheel; and
one or more processing circuits configured to perform vibration control of the vehicle by controlling the actuator based on a detection value of the sensor, wherein:
the vibration control includes
calculating a parameter related to vertical motion of each wheel based on the detection value of the sensor,
setting a high-pass filter for cutting off components having frequencies equal to or lower than a predetermined frequency from the parameter, based on a result of comparing the parameter with a predetermined upper limit value, and
calculating a control amount for the actuator of each wheel for controlling the suspension stroke based on the parameter from which the components having frequencies equal to or lower than the predetermined frequency have been cut off by filtering using the high-pass filter;
the parameter includes a heave component in which four wheels of the vehicle perform the same vertical motion, a pitch component in which left and right wheels of the vehicle perform the same vertical motion and front and rear wheels of the vehicle perform different vertical motions, and a roll component in which the left and right wheels of the vehicle perform different vertical motions;
the high-pass filter includes a first high-pass filter that is set when at least one of the heave component, the pitch component, and the roll component is equal to or greater than the predetermined upper limit value;
the first high-pass filter includes a first heave filter, a first pitch filter that is weaker than the first heave filter, and a first roll filter that is weaker than the first pitch filter; and
when the first high-pass filter is set in the setting of the high-pass filter, in the filtering, the first heave filter or the first pitch filter is applied to the heave component, a filter different from the filter applied to the heave component among the first pitch filter and the first roll filter is applied to the roll component, and the same filter as the filter applied to the heave component or the roll component, or a filter different from the filter applied to the heave component and the roll component among the first heave filter, the first pitch filter, and the first roll filter is applied to the pitch component.

2. The control system according to claim 1, wherein, when the first high-pass filter is set in the setting of the high-pass filter, in the filtering, the first heave filter is applied to the heave component, the first roll filter is applied to the roll component, and the first pitch filter is applied to the pitch component.

3. The control system according to claim 1, wherein:
the high-pass filter includes a second high-pass filter that is set when all of the heave component, the pitch component, and the roll component are less than the predetermined upper limit value;
the second high-pass filter includes a second heave filter that is weaker than the first heave filter, a second pitch filter that is weaker than the first pitch filter, and a second roll filter that is weaker than the first roll filter; and
when the second high-pass filter is set in the setting of the high-pass filter, in the filtering, any filter of the second heave filter, the second pitch filter, and the second roll filter is applied to the heave component, the pitch component, and the roll component.

4. The control system according to claim 1, wherein:
the high-pass filter includes a second high-pass filter that is set when all of the heave component, the pitch component, and the roll component are less than the predetermined upper limit value;
the second high-pass filter includes a second heave filter, a second pitch filter that is weaker than the second heave filter, and a second roll filter that is weaker than the second pitch filter; and
when the second high-pass filter is set in the setting of the high-pass filter, in the filtering, the second heave filter or the second pitch filter is applied to the heave component, a filter different from the filter applied to the heave component among the second pitch filter and the second roll filter is applied to the roll component, and the same filter as the filter applied to the heave component or the roll component or a filter different from the filter applied to the heave component and the roll component among the second heave filter, the second pitch filter, and the second roll filter is applied to the pitch component.

5. The control system according to claim 4, wherein, when the second high-pass filter is set in the setting of the high-pass filter, in the filtering, the second heave filter is applied to the heave component, the second roll filter is applied to the roll component, and the second pitch filter is applied to the pitch component.
